(19) United States
(12) Patent Application Publication
(10) Pub. No.: US 2013/0125748 A1
(43) Pub. Date: May 23, 2013

(54) PARTICULATE AND OTHER GASEOUS EMISSIONS FILTER

(71) Applicant: Calgon Carbon Corporation, Pittsburgh, PA (US)

(72) Inventors: Jack Elliot TAYLOR, Cramlington (GB); F.G.A. DE VREEDE, Klaaswaal (NL)

(73) Assignee: CALGON CARBON CORPORATION, Pittsburgh, PA (US)

(21) Appl. No.: 13/680,902

(22) Filed: Nov. 19, 2012

Related U.S. Application Data
(60) Provisional application No. 61/561,408, filed on Nov. 18, 2011.

(51) Int. Cl. B01D 53/04

(52) U.S. Cl. CPC B01D 53/0407
USPC 95/90; 96/154

(57) ABSTRACT

Filters including activated carbon cloth are described herein. Embodiments include a filter medium including at least one activated carbon cloth layer, at least one fibrous material layer, and at least one support layer, and filter cartridges including these filter mediums as well as methods for using these filter mediums to filter exhaust from diesel automobiles and diesel trucks.

### CROSS-REFERENCE TO RELATED APPLICATIONS

This application claims priority to U.S. Provisional Application No. 61/561,408, entitled, “Particulate and Other Gaseous Emissions Filter,” filed Nov. 18, 2011, which is incorporated herein by reference in its entirety.

### GOVERNMENT INTERESTS

Not applicable.

### PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND

Not applicable.

### SUMMARY OF THE INVENTION

Embodiments are directed to a filter medium including at least one activated carbon cloth layer, at least one fibrous material layer, and at least one support layer. Other embodiments are directed to a filter cartridge including a cartridge housing having at least one inlet port and at least one outlet port and a filter medium disposed within the cartridge housing between the at least one inlet port and the at least one outlet port, said filter medium including at least one activated carbon cloth layer, at least one fibrous material layer, and at least one support layer. Further embodiments are directed to methods for filtering diesel engine emission by passing diesel exhaust through at least one filter medium where the filter medium includes at least one activated carbon cloth layer, at least one fibrous material layer, and at least one support layer.

### DESCRIPTION OF DRAWINGS

For a fuller understanding of the nature and advantages of the present invention, reference should be made to the following detailed description taken in connection with the accompanying drawings, in which:

FIG. 1 is a cartoon of a filter medium having a sandwich structure in which each layer of the filter medium is individually illustrated and in which the core layer is an activated carbon cloth.

FIG. 2 is a diagram of a pleated filter medium in which the filter medium has a sandwich structure in which the core is an activated carbon cloth.

FIG. 3 is a diagram of a filter cartridge including a pleated filter medium having a sandwich structure in which the core is an activated carbon cloth.

FIG. 4 is a diagram of a filter cartridge including a pleated filter medium having a sandwich structure in which the core is an activated carbon cloth that is designed to filter diesel exhaust.

### DETAILED DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope which will be limited only by the appended claims.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

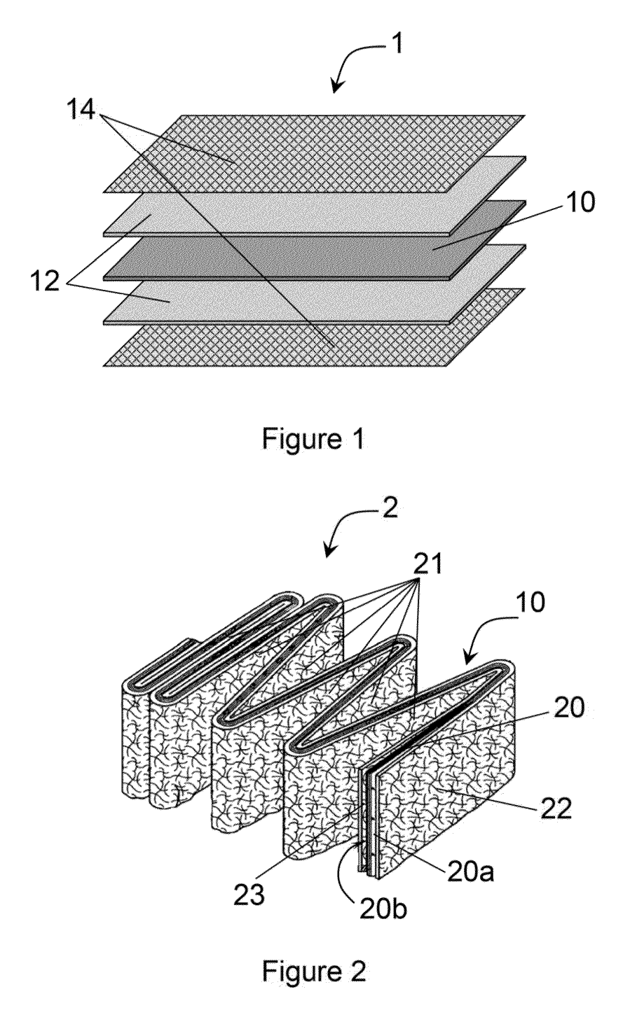

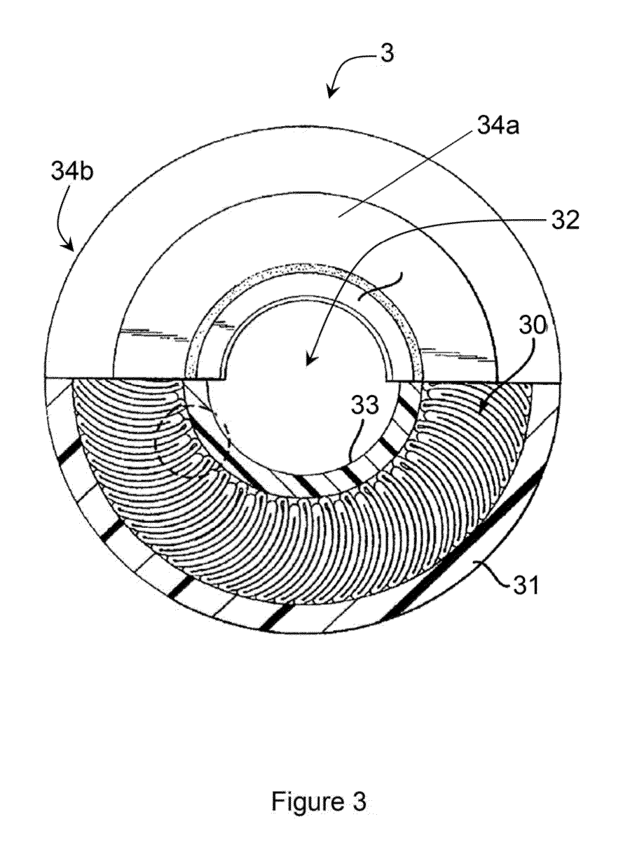

Various embodiments of the invention as exemplified in FIG. 1 are directed to a filter medium 1 including at least one activated carbon cloth layer 10, at least one fibrous material layer 12 and at least one support layer 14, and in some embodiments, the filter medium may be a pleated filter medium 2, see FIG. 2. In other embodiments, the filter medium 2 includes pleats 21. Such embodiments may include a core 20 comprising a first face 20a and a second face 20b, the core including at least one activated carbon cloth layer 10, a first fiber layer 22 and second fiber layer 23, each fiber layer including at least one fibrous material layer. The first fiber layer 22 is generally adjacent to, and substantially covers, the first face of the core 20a, and the second fiber layer 23 is generally adjacent to, and substantially covers, the second face of the core 20b. At least one support layer (not shown) may also be present and may be adjacent to, and substantially cover, one of the first fiber layer 22 or second fiber layer 23, and in particular embodiments, the pleated filter medium 2 may include first and second support layers, the first support layer being adjacent to, and substantially covering, the first fiber layer 22 and the second support layer being adjacent to, and substantially covering, the second fiber layer 23. Other embodiments are directed to methods for manufacturing such filter medium and devices and methods for using the filter medium 2 and devices for filtering fluids, in particular, gases.

Any type of filter cartridge known in the art may be designed to include the filter medium described above. In general, the filter cartridges of such embodiments may include one or more layers of a filter medium including at least one activated carbon cloth layer, at least one fibrous material layer, and at least one support material layer. In some embodiments, the filter medium contained in such filter cartridges may be pleated and, in other embodiments, the filter medium in the filter cartridge may by substantially flat or curved without having pleats.

In certain embodiments, the filter medium 30 may be incorporated into a device such as the cartridge 3, see FIG. 3, that can be used to filter fluids such as gases. Filter cartridges 3 of embodiments may be designed in any way and can incorporate various components known in the art. For example, in some embodiments, the filter cartridges 3 of embodiments, may include a cylindrical filter housing 31 that provides an outer covering for the filter medium 30 and an inner channel 32 that is defined by an inner channel wall 33. As illustrated in FIG. 3, the filter medium 30 may be positioned in a cavity created between the filter housing 31 and the inner channel wall 33. The filter cartridges 3 of various embodiments may further include end caps 34a and 34b, which cover either end of the cylindrical filter housing 31. The end caps, 34a and 34b, of various embodiments may be attached to the filter housing 31 using any means such as, for example, welding, push fittings, bolts, flanges, and the like, and combinations thereof. Such filter cartridges may be used to filter any fluid, and in particular embodiments, the filter cartridges may be used to filter exhaust from diesel engines to remove particulates.

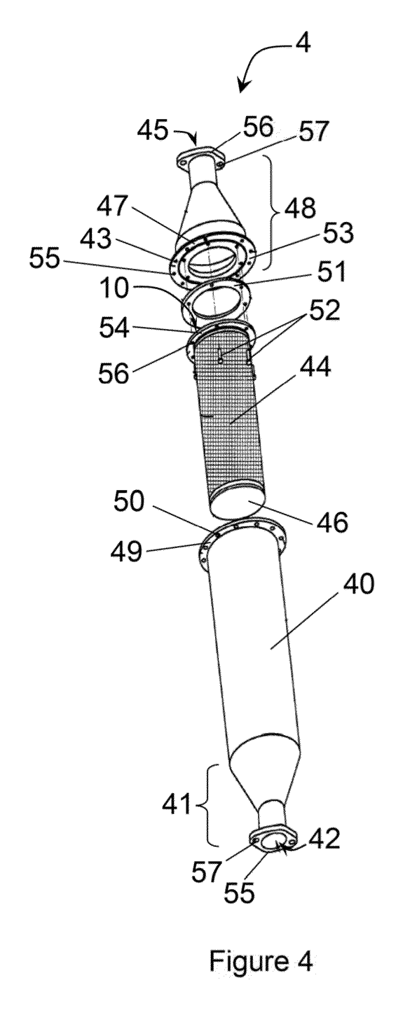

The filter cartridge may include any number or additional elements. FIG. 4 shows an exemplary filter cartridge having additional features. In particular, the filter cartridge 4 of FIG. 4 may include a cartridge housing 40 that may have an outlet port 42 fabricated on one end or an end cap 41 including an outlet port 42 associated with the cartridge housing 40. In some embodiments, the filter cartridge 4 may further include an internal filter cage 44 into which the filter medium 10 is placed before being inserted into the filter housing 40. In other embodiments, the filter medium 10 may be placed over the filter cage 44 (not pictured) before the filter cage 44 and the filter medium 10 are inserted into the filter housing 40. In particular embodiments, the filter cage 44 may have an end cap 46 that serves to route exhaust or other fluids through the filter medium 10 before the exhaust exits the filter cartridge 4 through the outlet port 42. The filters of such embodiments may further include an end cap 48 having an inlet port 45 that covers the open end of the filter housing 40 and encases the filter medium 10 in the filter cartridge 4 after the filter medium 10 has been inserted into the filter housing 40. The end cap 48 may be attached to the filter housing 40 by any means, for example, in some embodiments, the end cap 48 may be attached to the filter housing 40 by welding, or the end cap 48 may be secured to the filter housing 40 with bolts or rivets that are received through holes 43 in an end cap flange 47 and holes 50 in a filter housing flange 49. In further embodiments, the filter cartridge 4 may include additional gaskets, o-rings, spacers 51, and the like that can be secured to the cartridge using, for example, bolts 52. The end cap 48 and the filter housing 40 may include additional flanges 53 and 54, respectively, that allow the filter cage 44 to be attached to the end cap 48 to facilitate a tight seal between the end cap 48 and the filter cage 44, such that only gas that has passed through the filter exits the cartridge.

The end caps, 46 and 48, may further include flanges, 55 and 56, and bolt holes 57 and 58 through which bolts can be received for attaching the cartridge 4 to an exhaust system. The filter cartridge 4, bolt holes 57 and 58, and the flanges 55 and 56, of various embodiments, may be sized and shaped to fit into conventional exhaust systems and may be attached to such exhaust systems in place of conventional particulate filters. In other embodiments, the filter cartridge 4, exemplified above, may be designed to be incorporated into an exhaust system in addition to conventional particulate filters, and some embodiments include kits for fitting the cartridges of embodiments described above into existing exhaust systems. Such kits may include instructions for adding the filter to an existing exhaust system or retrofitting the existing exhaust system to accommodate the filter cartridge 4 as described above. Additional kits of embodiments may include various fittings, bolts, washers, spacers, clamps, and other hardware necessary for installing the cartridge of embodiments into an existing exhaust system or retrofitting the exhaust system to accommodate the filter cartridges 4 as described herein.

Embodiments of the invention are not limited to any particular activated carbon cloth 10, referring again to FIG. 1. For example, in various embodiments, the activated carbon cloth 10 may be a woven, non-woven, knitted, or felt activated carbon cloth. In other embodiments, the activated carbon cloth 10 may include activated carbon powders, particles, or fibers immobilized or attached to an otherwise non-activated carbon woven, non-woven, knitted, or felt activated carbon cloth material. In particular embodiments, the activated carbon cloth may be a woven or knitted activated carbon cloth having a microporous structure. Such activated carbon cloths may have a surface area of greater than about 750 m²/g, and in some embodiments, from about 1000 m²/g to about 2000 m²/g, and a surface density of from about 20 g/m² to about 200 g/m², from about 75 g/m² to about 150 g/m², or from about 100 g/m² to about 125 g/m². An example of such activated carbon cloths is ZORFLEX® ACC produced by Calgon Carbon Corp.

The fibrous material layer 12, in FIG. 1, may be formed from any material including, but not limited to polypropylene, polyethylene, polyester, and glass each of which may be used alone or in combination with one another. The fibrous material may generally be composed of non-woven fibers, and in some embodiments, the fibrous material layer 12 may be a non-woven fabric with needle punching. In other embodiments, the fibrous material layer 12 or portions of the fibrous material layer may be woven or knitted. For example, in certain embodiments, the fibrous material layer 12 may include a first fibrous material layer that is woven and is directly adjacent to the activated carbon layer and a second fibrous material layer that is non-woven adjacent to the woven or knitted fibrous material layer. In other embodiments, the fibrous material layer 12 may include two or more layers of woven, knitted, or non-woven fibrous material layers. The fibrous materials of various embodiments can be prepared in the form including, for example, melt-blow non-woven fabric, spun-bond non-woven fabric, glass fiber non-woven fabric, or a composite non-woven fabric of any of the above-mentioned fibers. The fibers themselves may have an average diameter of from about 1 μm to about 100 μm and, in some embodiments, from about 10 μm to about 50 μm. In various embodiments, the fibrous material layer 12 may have a basis weight of from about 20 g/m² to about 200 g/m², and in some embodiments, from about 35 g/m² to about 75 g/m².

In some embodiments, the filter medium 1 may further include a support layer 16, which may generally be composed of a rigid material that can be provided on one or both sides of the filter medium 1 adjacent to the fibrous material layers 12 to stiffen the filter medium 1 and allow the filter medium 1 to retain the desired shape. For example, in certain embodiments, the support layer 16 may be a metallic reinforcement such as a thin metal wire mesh. In other embodiments, the support layer 16 may be a polymer reinforcement material such as spunbond polypropylene or woven or non-woven polyester. The support layer 16 may provide support in a reverse flow/pressure condition and may insure that air flow is not obstructed between adjacent pleats if they are in contact. The upstream and downstream support medium layers 16 can be of the same or different construction.

In some embodiments, the support layer 16 may be provided on both sides of the filter medium 1 and may be attached to one another using, for example, metal or polymer ties or staples that hold the sandwich structure of the filter medium 1 together. In other embodiments, the filter medium 1 can further include adhesive layers between the activated carbon cloth layer 10, fibrous material layers 12, support layers 16 or combinations thereof that bond the layers together. Any adhesive known and used in the art may be used to bond the layers together including, for example, polyamide, polyolefin, ethylene-vinyl acetate copolymer, synthetic rubber, polyurethane, and acrylic resin in the form of hot melt or non-solvent emulsion. Bonding with a hot melt in the form of non-woven fabric or a hot melt spread like a spider's web is desirable from the standpoint of keeping pressure loss low and preventing the particulate adsorbing performance from deterioration. In certain embodiments, a priming treatment such as corona discharge and resin coating can be used to improve the affinity for the adhesive, thereby ensuring firm adhesion.

Certain embodiments may include other layers in filter medium 1 such as, for example, a thin layer of melt-blown material used to reduce migration adsorbent particles from filter medium layers. In other embodiments, the filter element may include filter medium layers having different filtering characteristics, for example, one layer acting as a pre-filter for the second layer. Varying the filtering characteristics of the plurality of filter medium layers may provide improved filtration. In some embodiments, several thin (about 1300 microns or less) filter medium layers can be stacked to obtain a total adsorptive medium thickness about equal to the conventional thickness (about 2500 to about 7500 microns). The resulting multi-layered filter element that can be pleated on any regular pleating machine (for instance, a Rabofsky E2000) commonly used within the industry.

In particular embodiments, the filter medium may be pleated 21, as illustrated in FIG. 2. Embodiments are not limited to particular pleat 21 designs. For example, in embodiments in which the filter medium 2 is used in a cylindrical filter element, the filter medium 2 may have radial pleats, spiral pleats, or a radial W-pleat configuration. Radial W-pleat configuration may provide added surface area about the outer periphery of the filter element by providing relatively short pleats that extend radially inward from the outer periphery of the filter element between adjacent pleats of standard height. These shorter pleats occupy the open space near the outer periphery of the filter element. They do not, however, maximize the amount of filter medium that can be disposed within the cartridge, as some empty space still remains between the pleats. The radial W-pleat construction also suffers from the effect of pleat migration, in that the shortened pleats tend to move radially inward towards the central axis of the filter. This movement is undesirable as it can cause binding, blockages, increased pressure drops across the filter, reduced filter life and can damage the filter medium. A spiral pleated filter includes a plurality of longitudinal pleats disposed in a cylindrical configuration. In a spiral pleated filter, the ends of the pleats are rolled over to minimize the spacing between adjacent pleat surfaces near an outer diameter of the filter element. In this case, the pleat height is substantially greater than the distance between the outer periphery of the cartridge core and the inner periphery of the cartridge cage. Consequently, in a conventional spiral pleated filter, the pleats at the outer periphery occupy the excess volume that would normally represent empty space in a radially pleated filter element. FIG. 3 shows a filter element 30 having a W-pleat construction.

In some embodiments, individual folds of the filter medium can be held apart using a pleat spacer. The pleat spacer may be fabricated from the same material as the housing and may include fingers that are capable of being inserted between the individual folds or pleats of the extended pleat filter medium as mounted inside the housing. The fingers of the pleat spacer separate the individual pleats from each other to prevent two adjacent pleats from collapsing together, thereby increasing air flow through the air filter. In other embodiment, the fingers may be triangular shaped pieces of material, a few inches in length, that are spaced at regular intervals along a common edge of a base strip. In other embodiments, the side edges of the pleated filter medium can be fitted into forms similar in shape and dimension to a pleat spacer. A pleat spacer may generally consist of a framework having receptacles that receive and hold a single pleat keeping the filter medium in its accordion-like shape.

In further embodiments, an adhesive may be used to seal the extended pleat filter medium into the forms, and in still other embodiments, forms may be bonded to a fabric such that the forms maintain the structure of the pleat filter medium while forming a loosely fitting seal between the side edges and the fabric. In yet another embodiment, an adhesive can be applied to bond the side edges to a fabric that holds the pleat filter medium in place within the housing. In such embodiments, a loosely fitting seal can be formed between the pleated filter medium and the walls of the housing eliminating airflow around the pleated filter medium and urging incoming air to pass through the pleat filter medium prior to exiting the air filter.

The pleated filter element 2 of various embodiments can be manufactured using a variety of techniques. For example, in some embodiments, the materials for each layer of the at least one activated carbon cloth layer 22, at least one fibrous material layers, 22a and 22b, and at least one support material layer to be combined in a filter medium can be stored on separate rolls and simultaneously fed into a machine and formed into a composite filter medium as the layers are combined. In other embodiments, adhesive layers may be provided between one or more of the material layers. In further embodiments, the machine may be a pleating machine configured to form pleats after the activated carbon cloth layer, fibrous material layers, and support material layer have been combined. In certain embodiments, the pleated composite may be heated to set an adhesive or one or more materials in the composite. In still other embodiments, the pleated filter composite that emerges from the pleating machine can be cut to a prescribed length or prescribed number of pleats as determined by the intended dimensions of filter element or cartridge, and the length of pleated filter composite can be formed into a cylindrical shape. In some embodiments, the lengthwise edges of the pleated filter element can be sealed to each other along a seam by conventional means such as, ultrasonic welding, to retain the pleated filter element in a cylindrical form. The cylindrical pleated filter element can then be axially inserted into a filter housing 40 as described above in relation to the filter cartridge 4 and end caps, 46 and 48, can be attached to the ends of filter housing 40 to form a complete filter cartridge 4 such as the filter cartridge illustrated in FIG. 4.

Further embodiments are directed to methods for using the filter medium described above including at least one activated carbon cloth layer, at least one fibrous material layer, and at least one support material layer. In some embodiments, such methods may include the step of passing a fluid, such as exhaust gas, over the filter medium. Such methods generally include the step of reducing the amount of particulates in a fluid stream such as exhaust from a diesel engine, and this reduction in the amount of particulates by the filter medium of embodiments is generally superior to known filter mediums. In other embodiments, such methods may include the steps of routing a fluid stream such as an exhaust stream such that the stream passes over the filter medium. In such embodiments, the fluid stream may be enclosed in a series of conduits such as an exhaust system as found in an automobile or truck exhaust system, and in some embodiments, the exhaust stream may pass through one or more other components such as, for example, a muffler, catalytic converter, or the like, before exiting the exhaust system and entering the environment. Such components are well known in the art and can be found on existing exhaust systems. Embodiments of the invention include exhaust systems including any number of such components.

Although the present invention has been disclosed above, the disclosure does not limit the present invention. Persons having ordinary skill in the art can make any changes or modifications without departing from the spirit and scope of the present invention. Consequently, the scope of protection of the present invention is based on the claims attached.

### EXAMPLES

### Example 1

A high heat resistance (>1000° C.) soot filter including one layer activated carbon cloth between two layers of fine stainless steel mesh wire was fabricated for in-line introduction into the exhaust system of diesel fueled DAF LF 45 series trucks and was tested for soot emission under driving conditions. More specifically, the soot filter included a stainless steel canister that was open at both ends having a size allowing it to be inserted into a section of the exhaust pipe of a standard delivery truck. A three component filter include one layer of SS meshwire, one layer activated carbon cloth, and one layer of SS meshwire was formed in the canister. The activated carbon cloth had a surface density of at least 110 gsm (g/m²) and a thickness of at least 0.5 mm and can be either knitted and/or woven. A fiberglass layer was used to seal the pleated carbon cloth layer against the filter casing.

The soot filter was mounted contiguously with the exhaust flow, and soot level was monitored at the exhaust outlet at local service stations. The exhaust value is based on light absorption with a value k (1/m) with increased soot load resulting in a higher light absorption value. The initial exhaust value for the for the truck without a filter was measured as 0.2 k, and the exhaust value was reduced to 0.1 k (50% reduction) by addition of the filter into the exhaust system when measured under the same running conditions. The soot filter also reduced emissions of exhaust gases including carbon monoxide from about 2.1 g/kWh to about 1.5 g/kWh, hydrocarbons from about 0.66 g/kWh to about 0.46 g/kWh, and nitrogen oxides from about 5.0 g/kWh to about 3.5 g/kWh and particulate matter from about 0.10 g/kWh to about 0.02 g/kWh and smoke from about 0.8 m⁻¹ to about 0.5 m⁻¹ elevating the tier of the truck from the European emissions standard EU 3 to EU 4. In addition, the noise level of the exhaust decreased from 108 dB to 98 dB when the engine was run at full power.

What is claimed is:

1. A filter medium comprising:
at least one activated carbon cloth layer; and
at least one support layer.

2. The filter medium of claim 1, wherein the at least one activated carbon layer comprises a core.

3. The filter medium of claim 2, further comprising a first fiber layer adjacent to, and substantially covering, a first face of the core and a second fiber layer adjacent to, and substantially covering, a second face of the core, wherein each fiber layer comprises at least one fibrous material layer.

4. The filter medium of claim 3, further comprising at least one support layer adjacent to, and substantially covering one of the first fiber layer, the second fiber layer, or a combination thereof.

5. The filter medium of claim 3, further comprising a first support layer adjacent to, and substantially covering, a face of the first fiber layer and a second support layer adjacent to, and substantially covering, a face of the second fiber layer.

6. The filter medium of claim 1, wherein the filter medium is a pleated filter.

7. The filter medium of claim 1, wherein the activated carbon cloth comprises a woven, a non-woven, a knitted, or a felt activated carbon cloth.

8. The filter medium of claim 1, wherein the at least one activated carbon cloth layer comprises two or more layers each of said two or more layers independently being selected from the group consisting of woven, non-woven, knitted, and felt activated carbon cloths.

9. The filter medium of claim 1, wherein the activated carbon cloth comprises a microporous structure.

10. The filter medium of claim 1, wherein the activated carbon cloth comprises a surface area of greater than about 750 m²/g.

11. The filter medium of claim 1, further comprising a fibrous material layer selected from the group consisting of polypropylene, polyethylene, polyester, or glass.

12. The filter medium of claim 11, wherein the fibrous material layer is non-woven.

13. The filter medium of claim 11, wherein the fibrous material layer comprises melt-blow non-woven fabric, spun-bond non-woven fabric, glass fiber non-woven fabric, or a composite non-woven fabric.

14. A filter cartridge comprising:
a cartridge housing having at least one inlet port and at least one outlet port; and
a filter medium disposed within the cartridge housing between the at least one inlet port and the at least one outlet port, said filter medium comprising:
at least one activated carbon cloth layer;
at least one fibrous material layer; and
at least one support layer.

15. The filter cartridge of claim 14, wherein the filter medium is pleated.

16. The filter cartridge of claim 14, wherein the filter cartridge is integrated into an exhaust system of a diesel automobile or a diesel truck.

17. A method for filtering diesel engine emission comprising passing diesel exhaust through at least one filter medium, said filter medium comprising:
at least one activated carbon cloth layer; and
at least one support layer.

18. The method of claim 17, further comprising routing an exhaust stream from the diesel engine such that the exhaust passes through the at least one filter medium.

19. The method of claim 17, wherein the filter medium comprises a filter cartridge.

20. The method of claim 17, wherein the filter medium is integrated into an exhaust system of a diesel automobile or a diesel truck.
